(19) United States
(12) Patent Application Publication
(10) Pub. No.: US 2016/0071144 A1
(43) Pub. Date: Mar. 10, 2016

(54) USER ACTIVITY ATTRIBUTION

(71) Applicant: Microsoft Corporation, Redmond, WA (US)

(72) Inventors: Bassel Abedi, Paris (FR); Wassim Jouini, Paris (FR); Damien Auroux, Paris (FR); Antoine Cellerier, Bourg la Reine (FR); Bastien Teinturier, Paris (FR)

(21) Appl. No.: 14/482,420

(22) Filed: Sep. 10, 2014

(51) Int. Cl. G06Q 30/02

(52) U.S. Cl. CPC G06Q 30/0246; G06Q 30/0273

(57) ABSTRACT

Embodiments are disclosed for attributing user actions to an appropriate referrer. An example system may attribute behavior of a user in an advertiser application of the advertiser to the user's selection of a promotion link presented within a user experience provided by a publisher on a client device. The example system includes a logic machine, a storage machine, and instructions stored within the storage machine executable to receive user click traffic in response to the user selecting the promotion link. The instructions are further executable to generate a token including information relating to the user click traffic, cause the advertiser application to be opened in response to the user click traffic via one or more of an instruction or application identifier that includes the token, and selectively attribute one or more user actions to the user's selection of the promotion link.

### BACKGROUND

Affiliation enables advertisers to provide content to an affiliate network, which may in turn distribute the advertiser's content to various publishers for use in associated user experiences. For example, a publisher's web site may include a link to purchase content via an advertiser, and user interaction with the link may be recorded by the affiliate network and attributed to the publisher. Advertisers may use such attribution to track user referrals and compensate publishers accordingly.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Embodiments are disclosed for attributing user actions across multiple platforms and/or applications to an appropriate referrer (e.g., a publisher of a user experience). An example system, operated by an advertiser, may be configured for attributing behavior of a user in an advertiser application of the advertiser to the user's selection of a promotion link presented within a user experience provided by a publisher on a client device, the publisher being one of a plurality of different publishers that are independent of the advertiser and that promote products or services of the advertiser. The example system includes a logic machine, a storage machine, and instructions stored within the storage machine, said instructions being executable by the logic machine to receive user click traffic in response to the user selecting the promotion link. The instructions are further executable to generate a token including information relating to the user click traffic, the token being transparent to the advertiser application, cause the advertiser application to be opened in response to the user click traffic via one or more of an instruction or application identifier that includes the token, and, for one or more user actions of the user in the advertiser application, selectively attribute such user actions to the user's selection of the promotion link.

### BRIEF DESCRIPTION OF THE DRAWINGS

FIG. 1 shows an example user experience provided by a publisher.

FIG. 2 is a block diagram of an example user action attribution system.

FIGS. 3A and 3B show example communication diagrams for attributing user login activity to a publisher.

FIG. 4 shows an example communication diagram for selectively attributing user purchase actions to a publisher.

FIG. 5 shows example attributions for different types of user actions in different time periods.

FIG. 6 is a flow chart of a method for selectively attributing user actions to a publisher.

FIG. 7 is a block diagram of an example computing system.

### DETAILED DESCRIPTION

Some affiliate services may allow the selection of links or other interaction within a user experience to be attributed to a publisher. However, with such services, if the links lead the user to another web page or application, user activity within such secondary experiences may not be recorded or attributable to the initial interaction with the publisher's user experience. The present disclosure provides systems and methods for selectively attributing user activity within advertiser applications by passing information relating to the user activity on the publisher's user experience (e.g., a publisher identifier) to an advertiser's reporting service via the application.

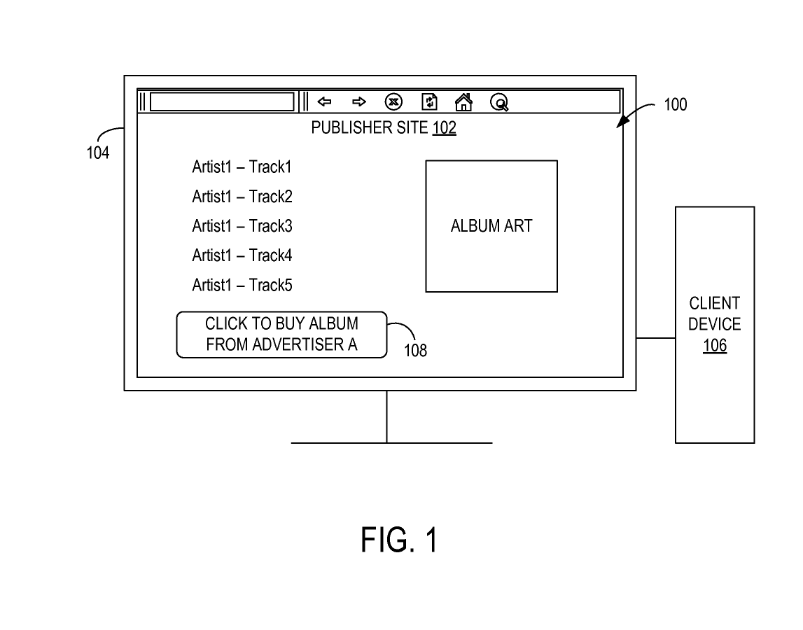

FIG. 1 shows an example user experience 100 provided by a publisher. The illustrated example user experience includes a web site 102 for the publisher, as displayed on a display device 104 of a client device 106. It is to be understood that the user experience 100 illustrated in FIG. 1 is exemplary in nature and is not limiting in any manner. For example, while the user experience 100 is depicted as a publisher's web page displaying music album information and a user-interactive button 108 directing a user to buy the album from an advertiser, any suitable user experience and advertisement may be utilized. In other examples, the user experience may be a mobile application for a portable computing device and the advertisement may be a user-interactive banner. It is to be understood that the user experience may be any suitable experience (e.g., web page, application, television program, etc.) provided on any suitable client device (e.g., a personal computer, a portable computing device/laptop/smartphone/tablet, a television, a video game console, etc.). The user experience may further provide access to advertiser content via any suitable mechanism, including but not limited to user-interactive buttons, links, banners, pop-up windows, prompts, etc.

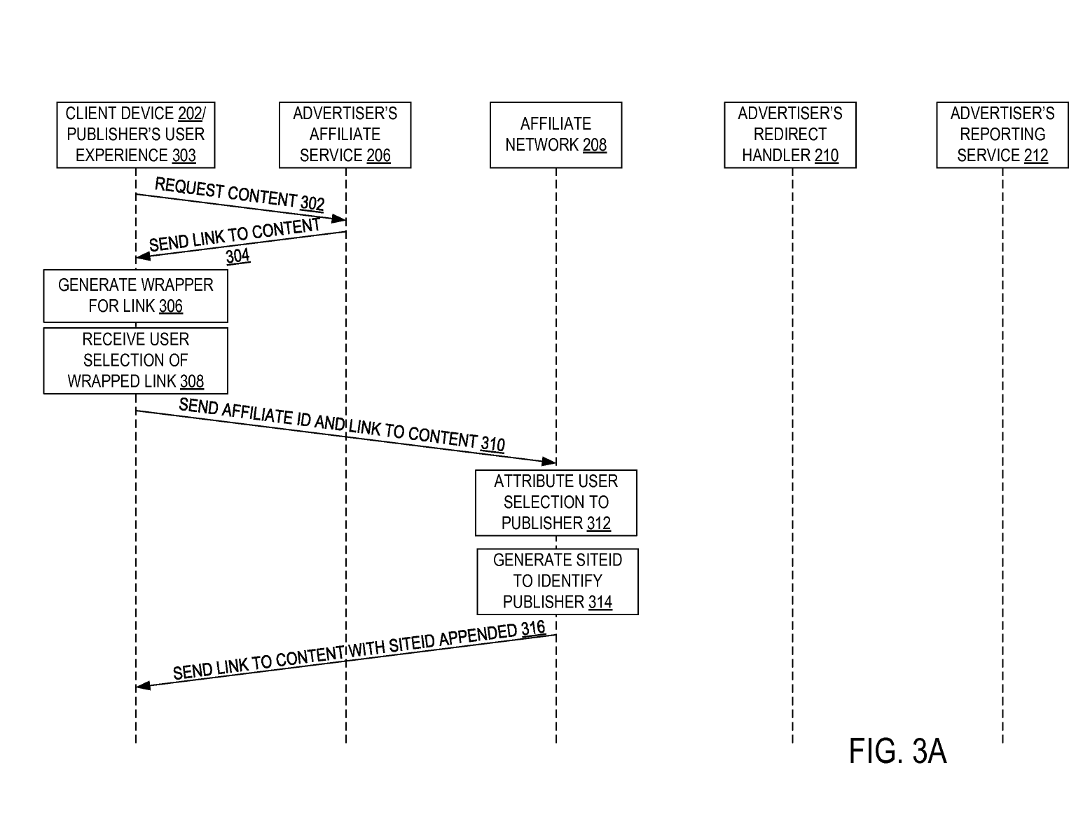

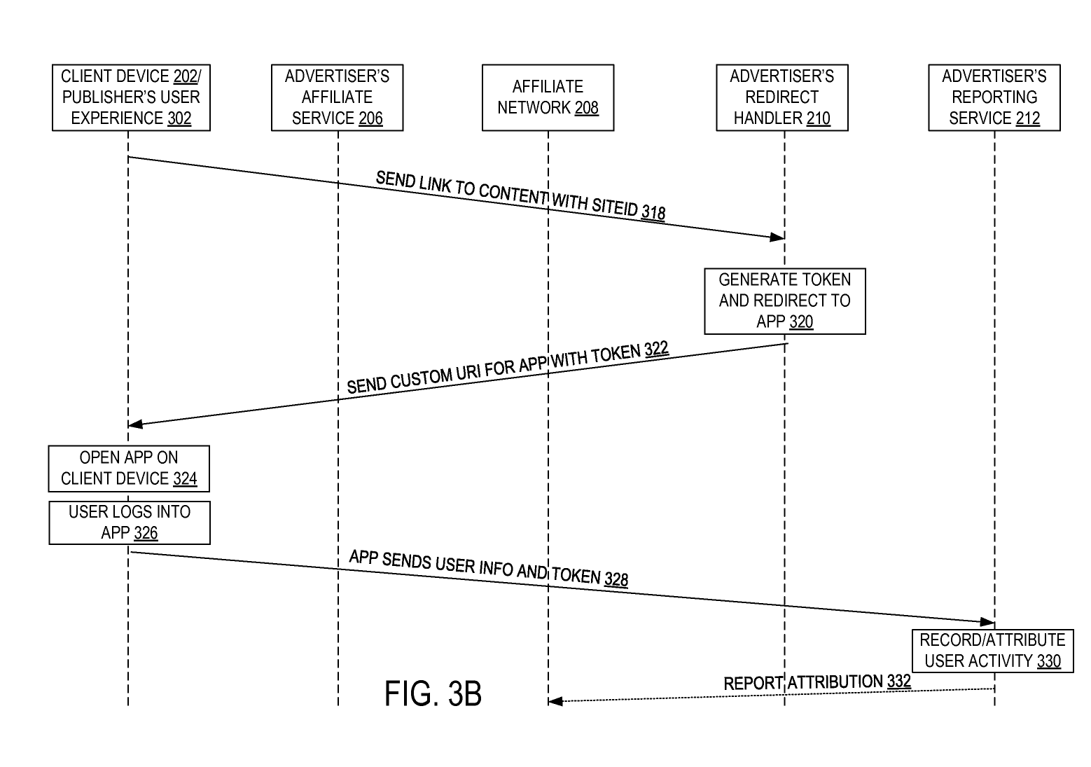

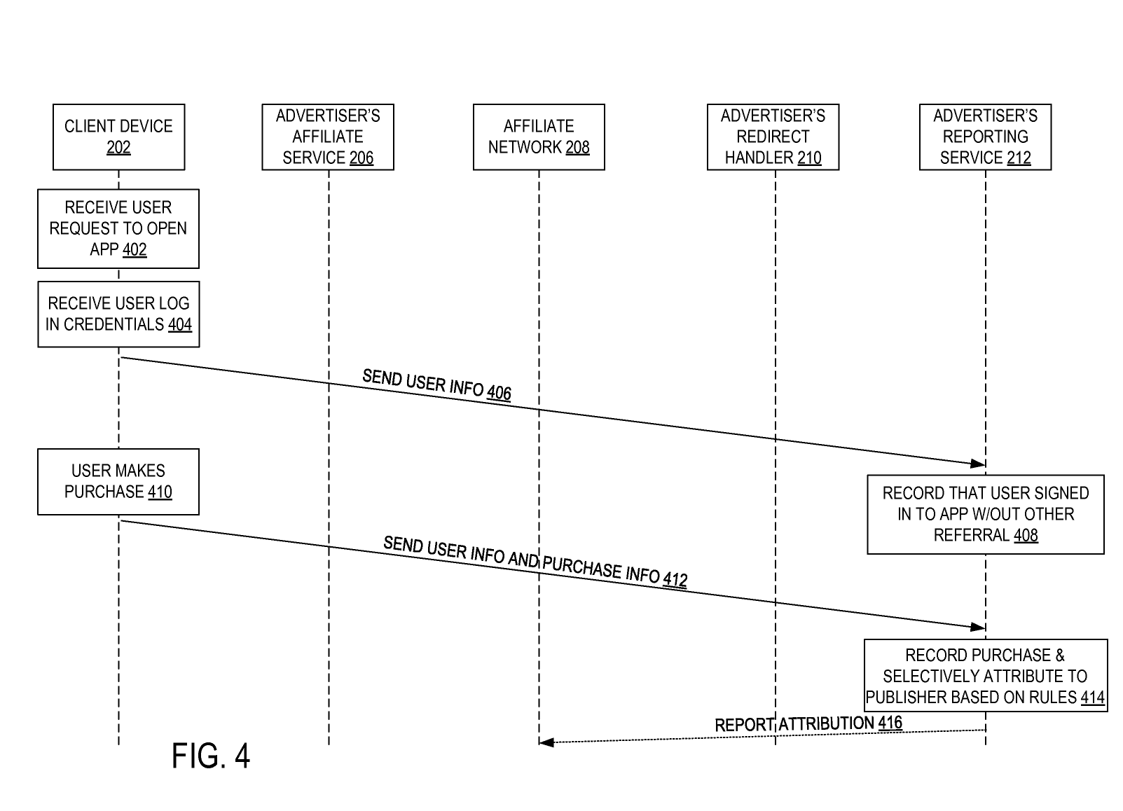

In the example illustrated in FIG. 1, the advertisement provided by button 108 may be provided in the publisher's site 102 due to the relevance of the advertisement to the displayed content. For example, the publisher's site may list information for a music album and the publisher may acquire and present a link to purchase that music album from the advertiser. As will be described in more detail below with regards to FIGS. 3A, 3B, and 4, the link may redirect a user to an affiliate network to register the user's selection of the link and then redirect the user to the advertiser's content. As the advertiser's content may be included in an advertiser application (e.g., a music distribution application for the example illustrated in FIG. 1), redirecting the user to the advertiser's content may include launching or otherwise entering the advertiser's application. For example, the advertiser's application may regain system focus if the application was already running in the background when the user selects the link.

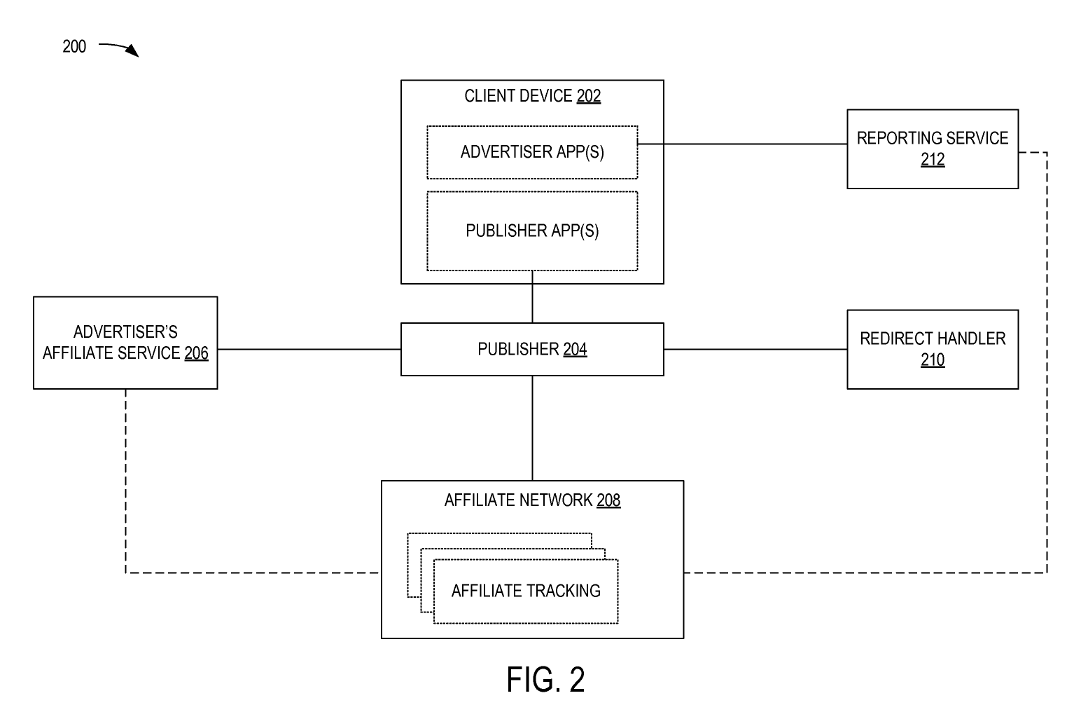

FIG. 2 is a block diagram of an example user action attribution system 200. As illustrated, attribution system 200 may include a client device 202 (an example of which is illustrated as client device 106 in FIG. 1) that hosts one or more advertiser applications and one or more applications providing access to publisher content (e.g., providing access to a publisher experience). For example, as described above, an advertiser application may include a music distribution application or any other suitable application providing access to advertiser content. A publisher application may include a web browser, a mobile device application, and/or any other suitable application providing access to the publisher's user experience. Accordingly, the client device 202 may access the user experience provided by publisher 204 via the publisher application.

Publisher 204 may receive a link to the advertiser content via the advertiser's affiliate service 206. For example, the advertiser's affiliate service 206 may be configured to locate and/or generate links to advertiser content and provide the links to different publishers. As both the publisher and the advertiser may be registered with an affiliate network 208, the publisher may generate a wrapper link that redirects to the affiliate network and identifies the advertiser content as well as the publisher/affiliate program information (e.g., information that enables the affiliate network to accurately register a user's selection of the link as being associated with the publisher and the advertiser). The affiliate network 208 may be a service that registers a plurality of advertisers and publishers, allowing selection of an advertiser's link/content on a publisher's user experience to be attributed to the publisher. The advertiser may utilize this attribution and/or other affiliate tracking data to determine compensation for the publisher associated with the user activity. The affiliate network may extract the deep link from the advertiser's affiliate service and append some affiliate tracking data (e.g., a site identifier for the publisher's experience and/or other suitable information) to generate a modified deep link. The modified deep link may be provided to the publisher and may cause the publisher's user experience to access the address included in the deep link.

The deep link provided by the advertiser's affiliate service 206 and utilized in the publisher's user experience may address a redirect handler 210 such that the redirect handler 210 is accessed after the selection of the link is registered with the affiliate network. Redirect handler 210 may include a web service that is configured to receive traffic brought by the publishers through redirects and examine the link/redirect information and determine/select an advertiser application to be utilized to access the content referenced in the link (e.g., based on the request parameters, the user's browser information, and/or other suitable criteria). The redirect handler may also generate an identifier of the selected advertiser application (e.g., a custom protocol uniform resource identifier [URI]) that is configured to cause and/or trigger the application to launch on the client device 202. The identifier may include a token appended thereto and/or embedded therein. The redirect handler may generate the token based on the affiliate tracking data received from the affiliate network via the publisher in a manner that obfuscates the tracking data from the selected advertiser application. In this way, the information may be sent to, but not processed by, the selected advertiser application.

The selected advertiser application may be configured to pass information (e.g., user log in information, user activity, etc.) to reporting service 212. Accordingly, the selected advertiser application may append the token to information sent to the reporting service in order to pass along the affiliate tracking information. In this way, the user activity can be tracked across platforms/applications by sharing tracking data (e.g., publisher identification) across the platforms/applications via the token. The reporting service may report any event that may be relevant for tracking user actions that could lead to revenue-sharing with a publisher, such as the opening of an application triggered by the redirect handler service and the associated token, a user sign-in in the application, and/or any other user action that could trigger an affiliate revenue share (e.g., a content purchase, subscription purchase, and/or any other kind of action rewarded by the affiliate program).

In some embodiments, the reporting service may provide tracking data to the affiliate network to supplement the information (e.g., the link selections) registered therewith. In this way, the affiliate network may continue to manage compensation calculations for the advertiser by providing all acquired/tracked data regarding user activity in association with the publisher/the links provided in the publisher's user experience. A recurring job may be executed on one or more of the components of FIG. 2 (e.g., on the affiliate network, the reporting service, etc.), which may analyze all reported events from the advertiser's applications and, depending on the business rules of the affiliate program and the timeline of these events, identify which specific user actions lead to revenue sharing with which specific affiliate publishers. The recurring job may further generate a full financial report of all of the revenue shares for a given affiliation network and provide access to the report to the advertiser. Although illustrated as separate components for descriptive purposes, it is to be understood that one or more of the blocks in FIG. 2 may be included in a single computing device/system. For example, redirect service 210 and reporting service 212 may be integrated in the same advertiser computing system.

FIGS. 3A and 3B show example communication diagrams for attributing user login activity to a publisher. At 302, the publisher providing user experience 303 (e.g., as executed on client device 202 of FIG. 2) may request advertiser content (e.g., a music album in the example described with respect to FIG. 1) from the advertiser's affiliate service 206. For example, the publisher may search and/or look up an advertiser item that the publisher intends to advertise in the user experience. In response, the advertiser's affiliate service may send a link (e.g., a deep link) to the requested content to the publisher for use in publisher's user experience at 304.

At 306, the publisher's user experience generates a wrapper for the link that redirects the link to affiliate network 208. The wrapped link may include the deep link, with an address (e.g., a uniform resource locator [URL]) for the affiliate network appended thereto, prepended thereto, and/or otherwise included therein. At 308, the publisher's user experience receives a user selection of the wrapped link. For example, the user may select (e.g., tap, click, provide a voice command, gesture, or otherwise provide input to the client device) an advertisement (e.g., a user-interactive graphical or text-based object in the user experience) for the advertised content. Selection of the link may cause the publisher's identifier and the link to the content to be sent to the affiliate network 208 at 310. At 312, the affiliate network attributes the user selection of the link to the publisher. In some examples, such attribution may include increasing a counter associated with the publisher and the advertiser to indicate an additional user selection of the link in the publisher's user experience.

At 314, the affiliate network generates a site ID or other identifier to identify (e.g., uniquely identify) the publisher and/or other entities, such as a current redirect. The affiliate network may then send the deep link to the advertised content back to the publisher's user experience with the site ID appended thereto, as indicated at 316. It is to be understood that additional or alternative information to the publisher identifier may be appended to the deep link by the affiliate network. For example, some affiliate networks may collect additional or alternative tracking data, such as data indicating information regarding the user, the user experience, the context of the link selection (e.g., other events that occurred around the time the user made the selection), and/or other suitable data. Some or all of the collected tracking information may be appended to the deep link and sent to the publisher's user experience by the affiliate network at 316, and references to “site ID” herein is intended to include some or all of such appended information.

Continuing to FIG. 3B, at 318, the publisher's user experience may automatically (e.g., without receiving additional input from the user) access the advertiser's redirect handler via the deep link upon receiving the deep link and site ID from the affiliate network. The advertiser's redirect handler may generate a token based on the site ID (or other tracking data) and redirect the client device to a selected advertiser's application (e.g., an application selected from a plurality of advertiser applications based on the deep link/content associated with the deep link, the publisher, the user, the operating system/applications available on the client device, and/or any other suitable criteria), as indicated at 320. The token generation may include encoding (e.g., generating a code based on the site ID that is decodable by another advertiser's component via a key available at the other advertiser's component and/or recoverable from the code), hashing (e.g., mapping the site ID and/or portions of the site ID to integers, characters, or other hashes), or otherwise obfuscating the site ID from the application, while still ensuring that the information may be passed along from the application to the reporting service (described in more detail below). At 322, the advertiser's redirect handler sends a custom protocol URI for the selected advertiser application including the token. For example, the URI may be configured to cause the selected advertiser application to open and/or execute on the client device and the token may be appended to and/or embedded within the URI.

In response to receiving the URI, the client device executing the publisher's user experience may open the selected advertiser application, as indicated at 324. In some embodiments, the selected advertiser application may enable a user to log in or otherwise provide an identity. Accordingly, at 326, the user may log into the application (e.g., provide a username and password and/or other log in credentials/authenticators). The application may send to the advertiser's reporting service the user information and pass along the token received from the redirect handler, as indicated at 328. The advertiser's reporting service may be configured to decode and/or otherwise extract the relevant tracking information from the token and associate the user identity/log in event with the publisher that provided the user experience and instigated the user log in. Accordingly, the advertiser's reporting service may record and/or attribute the user activity to the publisher, as indicated at 330. In some embodiments, the reporting service may report the recordation/attribution to the affiliate network at 332 in order to consolidate the tracking information for ease of compensation calculation.

FIG. 4 shows an example communication diagram for selectively attributing user purchase actions to a publisher for user activity that may not occur immediately following a selection of a link on the publisher's user experience. At 402, the client device 202 receives a request from the user to open a selected advertiser application. As discussed above, the application may include a user interface allowing the user to provide log in information. Accordingly, at 404, the client device may receive the user's log in credentials. The user information may be sent to the advertiser's reporting service at 406. At 408, the reporting service may determine and record the user log in event, noting that the user did not log in due to another referral. In other words, the communication diagram illustrated in FIG. 4 may occur at some point after the user clicks on a link from the publisher (e.g., after the events illustrated in FIGS. 3A and 3B) and without the user clicking on another, similar link (e.g., a link to the same content/that triggers the same advertiser application to open) from another publisher.

At 410, the user may make a purchase via the advertiser application and/or perform some other attributable action. In response, the user information and purchase information (e.g., content identifier for purchased content, time of purchase, time spent browsing, other items viewed, method of payment, and/or other suitable purchase information) may be sent to the reporting service at 412. At 414, the reporting service may record this information and selectively attribute the action to the publisher that originally referred the user to the application based on a set of attribution rules. In other words, if the user activity and associated tracking information meets a particular criterion or set of criteria, the user activity may be attributed to the publisher. Otherwise, the user activity may not be attributed to the publisher. If the activity is attributed to the publisher, this attribution may be reported to the affiliate network, as indicated at 416.

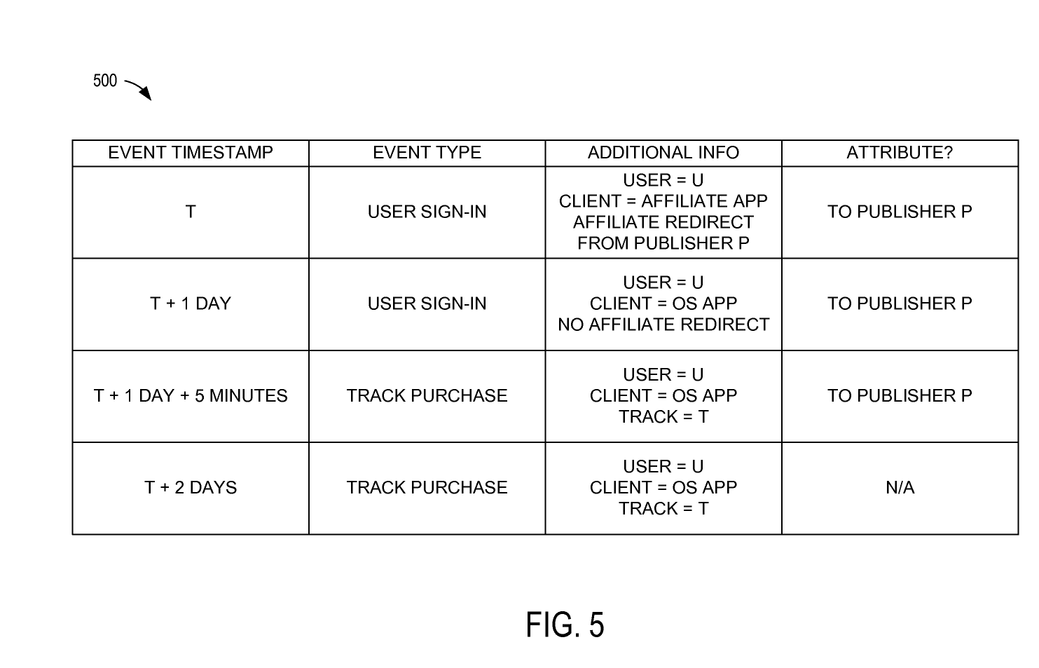

As described above, the selective attribution of user activity to a given publisher may be subject to one or more rules. In some embodiments, the rules may include temporal rules. FIG. 5 shows example attributions for different types of user actions in different time periods. It is to be understood that the recorded data and attribution illustrated in chart 500 of FIG. 5 is exemplary in nature, and any suitable rules may be applied without departing from the scope of this disclosure. As indicated in the table, the user may log in at time T, and information including a user identity (“U”), a client into which the user logged in (“Affiliate App”), and redirect information (“redirect from publisher P”) may be recorded at an advertiser's reporting service, such as reporting service 212 of FIG. 2. As indicated in the far left column, this action may be attributed to publisher P as publisher P is noted to have redirected the user to the advertiser application (e.g., as described at 308-324 of FIGS. 3A and 3B).

One day after the user logs into the application (“T+1 Day”), the user may log into a different advertiser application (“Client=OS app”) without having been referred directly by any particular publisher (“No affiliate redirect”). Despite logging into a different application on a different platform, the action is still attributed to the publisher P based on the earlier referral at time T and the fact that no other publisher referred the user. In this example, the time threshold (e.g., a threshold period of time) for attributing actions to a publisher may be some value greater than one day after an initial redirect/sign in event. In other examples where the time threshold is a value less than one day after the initial redirect/sign in event, the action at time T+1 day may not be attributable to the publisher if not accompanied by a redirect.

As indicated in the third row of chart 500, the user may make a purchase at time T+1 day+5 minutes within the OS application. The reporting service may track the time of the initial redirect (time T) and/or the time of the purchase and if the time of purchase relative to the time of the initial redirect falls within the time threshold for attributing actions, the action may be attributed to publisher P, as indicated in the far right column of chart 500. In contrast, user activity at time T+2 days may fall outside of the time threshold, thus that user activity may not be attributable to publisher P, as indicated by the “N/A” in the rightmost column of chart 500. It is to be understood that the time thresholds discussed herein are utilized for descriptive and exemplary purposes and are not intended to be limiting. In other examples, other suitable time thresholds and rules may be applied. For example, attribution may be based on the type of application in which the activity occurs, the amount of time between logging in and purchasing an item, other user activity, and/or any suitable criteria.

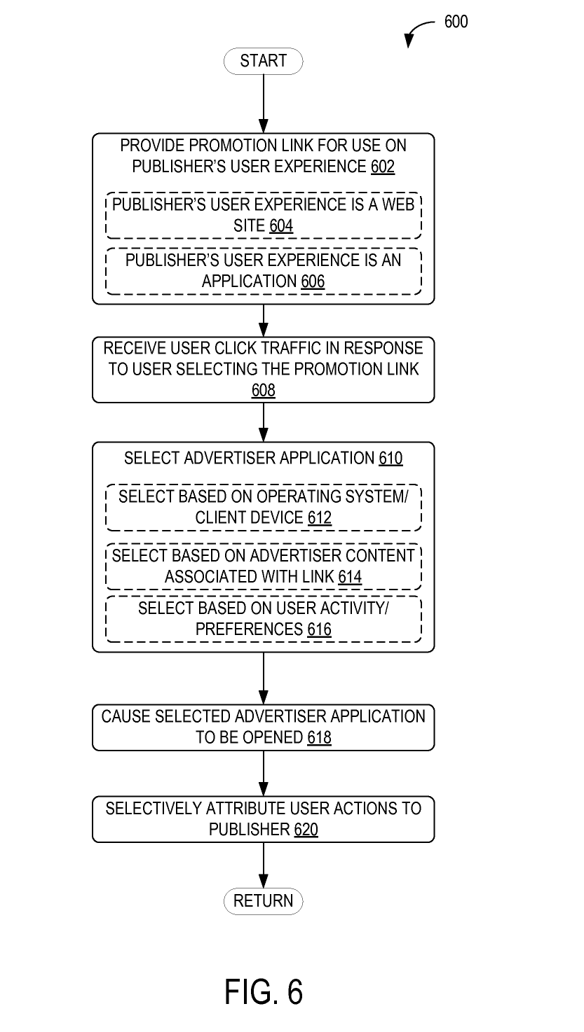

FIG. 6 is a flow chart of a method 600 selectively attributing user actions to a publisher. In some examples, method 600 may be performed by an advertiser system, which may include the affiliate service 206, the reporting service 212, and/or the redirect handler 210 of FIG. 2. At 602, method 600 includes providing a promotion link for use on a publisher's user experience. For example, the affiliate service 206 of FIG. 2 may provide the promotion link to a client device providing the publisher's user experience. In some examples, the publisher's user experience may be a web site, as indicated at 604, an application, as indicated at 606, and/or any other suitable user experience. At 608, the method includes receiving user click traffic in response to the user selecting the promotion link. In some embodiments, the user click traffic may be forwarded to the redirect handler 210 of FIG. 2 including information provided by an affiliate network (e.g., a publisher identifier).

At 610, the method includes selecting an advertiser application. For example, the redirect handler 210 of FIG. 2 may select an advertiser application based on the operating system/client device providing the publisher's user experience, as indicated at 612. In additional or alternative examples, the advertiser application may be selected based on the advertiser content associated with the link, as indicated at 614, user activity/preferences, as indicated at 616, and/or any other suitable criteria. At 618, the redirect handler may cause the selected advertiser application to be opened (e.g., by sending a custom protocol URI identifying the selected application and/or otherwise commanding the client device to execute the selected application). At 620, the method may include selectively attributing user actions to the publisher. For example, the advertiser reporting service 212 of FIG. 2 may attribute user actions to the publisher based on rules, such as the temporal rules described above, rules pertaining to the context of the user actions, and/or any other suitable rules.

As described herein, the redirect handler 210 and reporting service 212 of FIG. 2 ensure that tracking information may be persistent across different advertiser applications and client device platforms, allowing user activity across these entities to be tracked and attributed to initial redirect events (e.g., an initial selection of a link in a publisher's user experience). In this way, the system recognizes that an advertisement's presence on the publisher's user experience may be the trigger for later user actions, even if said actions occur at a later time, on a different platform, in a different application, etc. Accordingly, the publisher may be fairly compensated and improved statistical data may be collected to determine a context of a user's actions in the advertiser's application(s).

In some embodiments, the methods and processes described herein may be tied to a computing system of one or more computing devices. In particular, such methods and processes may be implemented as a computer-application program or service, an application-programming interface (API), a library, and/or other computer-program product.

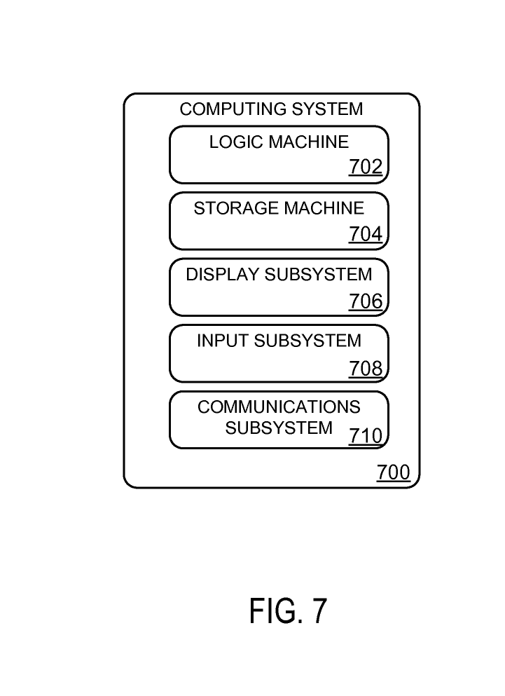

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices. For example, computing system 700 may take the form of one or more of the components described with regards to FIG. 2, such as the client device 202, the reporting service 212, and/or the redirect handler 210.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A system, operated by an advertiser, for attributing behavior of a user in an advertiser application of the advertiser to the user's selection of a promotion link presented within a user experience provided by a publisher on a client device, the publisher being one of a plurality of different publishers that are independent of the advertiser and that promote products or services of the advertiser, the system including:
a logic machine;
a storage machine; and
instructions stored within the storage machine, said instructions being executable by the logic machine to:
receive user click traffic in response to the user selecting the promotion link;
generate a token including information relating to the user click traffic, the token being transparent to the advertiser application;
cause the advertiser application to be opened in response to the user click traffic via one or more of an instruction or application identifier that includes the token; and
for one or more user actions of the user in the advertiser application, selectively attribute such user actions to the user's selection of the promotion link.

2. The system of claim 1, where the advertiser application is a selected advertiser application and is one of a plurality of different advertiser applications of the advertiser, the instructions being executable to select the selected advertiser application from the plurality of different advertiser applications and cause the selected advertiser application to be opened.

3. The system of claim 2, wherein the selected advertiser application is selected based on an identifier of an operating system of a client device on which the promotion link is presented.

4. The system of claim 2, wherein the selected advertiser application is selected based on advertiser content associated with the link.

5. The system of claim 2, wherein the instructions are further executable to attribute user action in an advertiser application that is different from the selected advertiser application to the selection of the promotion link.

6. The system of claim 2, wherein causing the selected advertiser application to open includes sending a uniform resource identifier (URI) to the client device providing the user experience, the token being appended to the URI.

7. The system of claim 2, wherein the instructions are further executable to report, to an affiliate network, the attribution of the user actions.

8. The system of claim 2, wherein the token includes information received at the user experience from an affiliate network identifying the publisher.

9. The system of claim 8, wherein the information includes one or more of an identifier of the publisher and an identifier of the user experience.

10. The system of claim 2, wherein selectively attributing the user's actions to the user's selection of the promotion link includes attributing the user's actions to the user's selection of the promotion link if the user's actions occur within a threshold period of time from selecting the promotion link.

11. The system of claim 10, wherein the threshold period of time is selected based on a type of user action.

12. A system, operated by an advertiser, for attributing behavior of a user within one or more of a plurality of advertiser applications of the advertiser to the user's selection of a promotion link accessible within a user experience provided by a publisher on a client device, the publisher being one of a plurality of different publishers that are independent of the advertiser and that promote products or services of the advertiser, the system including:
a logic machine;
a storage machine; and
instructions stored within the storage machine, said instructions being executable by the logic machine to:
receive user click traffic in response to the user selecting the promotion link;
select, from the plurality of advertiser applications of the advertiser, a selected advertiser application to be opened in response to the user click traffic; and
for one or more user actions of the user in either the selected advertiser application or one or more other advertiser applications in the plurality of advertiser applications, attribute such user actions to the publisher and the user's selection of the promotion link.

13. The system of claim 12, wherein receiving user click traffic includes receiving publisher information.

14. The system of claim 12, wherein the instructions are further executable to report, to an affiliate network, the attribution of the user actions.

15. The system of claim 12, wherein the instructions are further executable to generate a token including information relating to the user click traffic, the token being transparent to the selected advertiser application.

16. The system of claim 15, wherein the instructions are further executable to embed the token into a link configured to trigger the opening of the selected advertiser application and send the link to the client device.

17. A method for attributing behavior of a user within one or more of a plurality of advertiser applications of an advertiser to the user's selection of a promotion link accessible within a user experience provided by a publisher, the publisher being one of a plurality of different publishers that are independent of the advertiser and that promote products or services of the advertiser, the method comprising:
receiving user click traffic in response to the user selecting the promotion link;
receiving traffic information generated by an affiliate network;
selecting, from the plurality of advertiser applications of the advertiser, a selected advertiser application to be opened in response to the user click traffic;
generating a token based on the traffic information;
sending the token and a command to open the selected advertiser application to the user experience provided by the publisher; and
for one or more user actions of the user in either the selected advertiser application or one or more other advertiser applications of the plurality of advertiser applications, receiving the token, receiving user information, and selectively attributing the one or more user actions to the publisher.

18. The method of claim 17, wherein the traffic information includes a publisher identifier.

19. The method of claim 17, wherein the token is generated to obfuscate the traffic information from the selected advertiser application.

20. The method of claim 17, further comprising reporting, to the affiliate network, the attribution of the one or more user actions.
